(19) United States
(12) Patent Application Publication
(10) Pub. No.: US 2002/0007311 A1
(43) Pub. Date: Jan. 17, 2002

(54) Method and system for registering and opening digital album and electronic service site running system

(76) Inventors: Daisuke Iseki, Tokyo (JP); Minoru Ikeda, Inagi (JP); Asako Katayama, Kodaira (JP)

Correspondence Address: ANTONELLI TERRY STOUT AND KRAUS, SUITE 1800, 1300 NORTH SEVENTEENTH STREET, ARLINGTON, VA, 22209

(21) Appl. No.: 09/854,459

(22) Filed: May 15, 2001

(30) Foreign Application Priority Data
May 16, 2000 (JP) 2000-148632

(51) Int. Cl. G06F 17/60

(52) U.S. Cl. 705/14; 705/26

(57) ABSTRACT

The present invention relates to an electronic service site for opening an electronic service site by preparing a mechanism for utilizing goods and services and application of transaction and connecting a plurality of user terminals via the telecommunication line. This electronic service site can be suitably applied to the digital album registering and opening method and digital album registering and opening system for enabling management and lending of such image information by accepting such image information.

In more practical, the digital album provider terminal receives the image information including the open YES/NO information and retrieval information from the image provider terminal, stores the received image information as the digital album, retrieves the image information matched with the digital album based on the retrieval request information from the image user terminal and provides the retrieved image information including the open YES information to the image user terminal.

### BACKGROUND OF THE INVENTION

As a preserving and utilizing system for photographic image data photographed a digital camera of the related art, there is proposed a system for providing services by storing photograph image data in a large capacity server installed in a camera shop and then providing services through downloading or printing of such stored data as disclosed in the Japanese Unexamined Patent Publication No. Hei 10-150523 (related art 1). This system records and stores the image data photographed by the a camera to the server from the terminals installed in various points via the communication line and thereby enables various output services to the storage requesting persons. In these services, the storage requesting persons can exchange the data with the other persons.

Moreover, as a multimedia information collection management system of the related art, there is proposed a system for providing information to terminals having accessed through the Internet by registering, to the database of the information management device, the multimedia information obtained using the public telephone line from an information collection device including a camera and a microphone and then opening such multimedia information through the Internet (related art 2).

However, the photograph image data storing and utilizing system of the related art 1 is limited only to use by a storage requesting person and this system cannot allow the third party to freely use the stored data by opening such stored data to the third party, resulting in the problem that the storage requesting person cannot share the storing expense to the third party and the third party cannot obtain the necessary image information.

Moreover, the multimedia information collection management system of the related art 2 can disclose the registered image data but does not describe that the image provider registers the image by giving the open YES/NO information and only the information given the open YES information can be opened to the third party.

### SUMMARY OF THE INVENTION

The present invention relates to an electronic service site by preparing a mechanism for making reference to goods and services and for proposing a transaction and connecting a plurality of user terminals to this electronic service site via the communication line that is particularly suitable for application to a method and a system for registering and opening digital album for management and lending of image information by receiving such image information.

The present invention has an object to provide a method and a system for registering and opening digital album in which it is no longer required to store the images in the terminal of image provider, the third party can conveniently utilize the image information which is registered allowing the opening thereof and thereby many users can take part in the system.

In order to achieve the object explained above, the digital album registering and opening method that is one of the typical inventions of the present invention discloses an electronic service site running system for enabling connection of a plurality of terminals to the electronic service site through the communication line by opening the electronic service site through preparation of the mechanism for storing image information and generating proposal to transaction. The running system explained above accepts image information having the open YES/NO information and retrieval information from the image provider terminal, stores the image information given the open YES information as the digital open album information, enables opening of the digital open album information at the electronic service site, accepts a retrieval request to the electronic service site from the image user terminal, retrieves, based on the retrieval request, the image information matched with the retrieval request from the digital opening album information and provides the retrieval result to the image user terminal.

Moreover, the running system stores the image information of which registration has been accepted as the digital private album information, enables retrieval, edition and output of the digital private album information via the electronic private service site, accepts the retrieval request for the electronic private service site from the image provider terminal which has requested registration of image, retrieves the image information matched with the retrieval request from the digital private album information based on the retrieval request and provides the retrieval result to the image provider terminal which has issued a request for storing the image.

### BRIEF DESCRIPTION OF THE DRAWINGS

FIG. 1 is a structural diagram of a digital album registering and opening system as an embodiment of the present invention.

FIG. 2 is a block diagram of an image provider terminal connected to the digital album registering and opening system of FIG. 1.

FIG. 3 is a block diagram of the digital album provider terminal.

FIG. 4 is a block diagram of the image user terminal.

FIG. 5 is a block diagram of a travel agency terminal.

FIGS. 6A, 6B are operation flow diagrams of the digital album registering and opening system.

FIG. 7 is a diagram of an example of ID/password input screen displayed on the image provider terminal.

FIG. 8 is a diagram of the screen transmission and retrieval selection screen example.

FIG. 9 is a diagram of a new and change transmission selection screen example.

FIG. 10 is a diagram of a transmission and selection screen example.

FIG. 11 is a diagram of a private registration screen example.

FIG. 12 is a diagram of a private register check screen example.

FIG. 13 is a diagram of a gathered screen example of examination of private image to be displayed on the image provider terminal or image user terminal.

FIG. 14 is a diagram of an opening and registration screen example to be displayed on the image provider terminal.

FIG. 15 is a diagram of an open and registration check list screen example.

FIG. 16 is a diagram of a registration point display and selection screen example.

FIG. 17 is a diagram of a retrieval and selection screen example to be displayed on the image user terminal.

FIG. 18 is a diagram of a retrieval result list screen example to be displayed on the image provider terminal.

FIG. 19 is a diagram of a finally selected image display screen example to be displayed on the image provider terminal.

FIG. 20 is a diagram of a gathered screen example of examination of open image.

FIG. 21 is a diagram of a retrieval result list screen example.

FIG. 22 is a diagram of a credit number input screen example.

FIG. 23 is a diagram of a finally selected image display screen example.

FIG. 24 is a structural diagram of a digital album registering and opening system of the other embodiment of the present invention.

### DESCRIPTION OF THE PREFERRED EMBODIMENTS

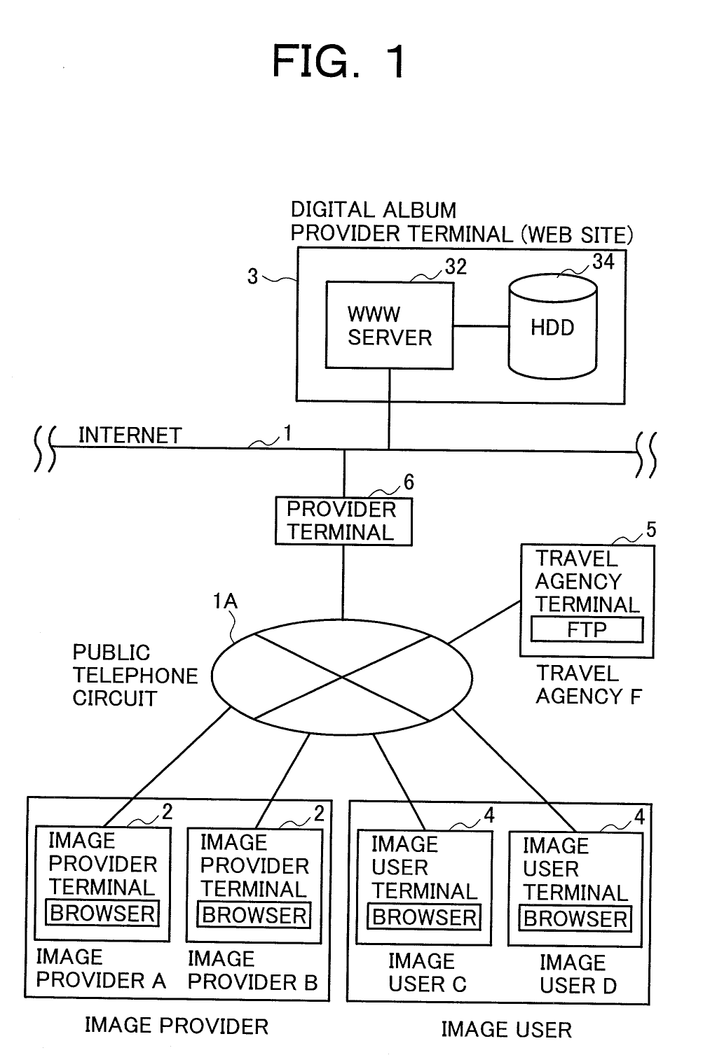

The electronic service site of the present invention will be explained with reference to FIG. 1 to FIG. 24.

First, the digital album registering and opening system in relation to the electronic service site of the present invention will be explained with reference to FIG. 1 to FIG. 23. FIG. 1 is a structural diagram of the digital album registering and opening system of an embodiment.

As illustrated in FIG. 1, in the digital album registering and opening system in which an electronic service site is opened is formed by connecting a plurality of image provider terminals 2, a plurality of image user terminals 4 and a travel agency terminal 5 to the digital album provider terminal 3 operated by a digital album service company through the Internet network 1 forming the communication line, a provider terminal 6 and the public telephone circuit 1A forming the communication line. This connection can be established when the registration application is approved after it is applied to the provider terminal 6 from a user terminal formed of the image provider terminal 2, image user terminal 4 and travel agency terminal 5. Therefore, the image provider, image user and travel agency can easily take part in this digital album registering and opening system through connection with the Internet network 1 via personal computers. In FIG. 1, the image provider is displayed with representative two providers of the image provider A and image provider B. Moreover, the image user is displayed with representative two users of the image user C and image user D. However, the present invention is not limited thereto and such providers and users may be selected from more or less providers or users. Moreover, the image user may become an image provider and the image provider may become the image user. For the convenience of explanation, these providers and users are explained separately here.

With this connection, the image provider terminal 2, image user terminal 4 and travel agency terminal 5 can transmit and receive the signal to and from the digital album provider terminal 3 via the public telephone circuit 1A, provider terminal 6 and Internet network 1. Namely, the image provider terminal 2 can request registration and opening of the image data picked up with a digital still camera and a digital video camera or the like as a digital album by providing such image data to the digital album provider terminal 3. Moreover, the image user terminal 4 and travel agency terminal 5 can use the digital album given the open YES information of the digital album provider terminal 3.

Namely, this embodiment has a distinctive characteristic that storage of image data can be requested with a charge and can receive the retrieval service of these images in the case where the image provider takes part in this system. Thereby, the image provider can freely edit the images picked up and store these images in this system and can also extract these images easily. Therefore, it is no longer required to provide a large capacity storage in the image provider terminal 2 and moreover storage of such images is unnecessary. The image provider can alleviate the storage charge or receive a compensation fee of the opening by adding, under the condition for the opening, the opening condition to the image information under the request of storage.

Moreover, the other characteristic of this preferred embodiment is that the image information can be easily provided for user who requires the image information by opening with a charge the image information registered with the image provider under the condition of opening. Since the image provider can alleviate the storage charge of the private image information by opening a part of the private image information and therefore can widely collect the image information, the image provider can provide versatile image information to the image users.

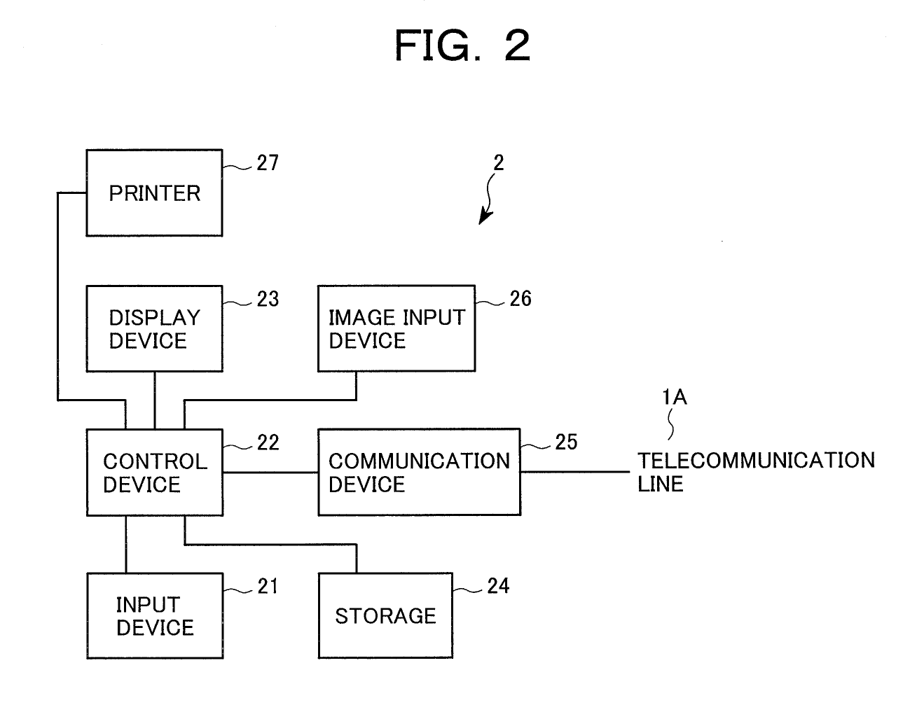

Next, the image provider terminal operated with an image provider will be explained practically with reference to FIG. 2. FIG. 2 is a block diagram of the image provider terminal connected to the digital album registering and opening system of FIG. 1.

As illustrated in FIG. 2, this image provider terminal 2 is formed of a personal computer installing a browser, including an input device 21, a control device 22, a display device 23, a storage 24, a communication device 25, an image input device 26 and a printer 27. The input device 21 includes a character input unit consisting of a keyboard or the like and is connected to the control device 22 to input thereto the input result. The control device 22 is constituted of a micro- computer to perform the predetermined step corresponding to the control operation of the digital album provider terminal 3. The display device 23 is constituted of a CRT display or a liquid crystal display device or the like and is connected to the control device 22 to display input contents and receiving contents or the like. The storage 24 stores the intrinsic information of an image provider and is connected to the control device 22. The communication device 25 has a function to enable the image provider terminal 2 to transmit and receive the data to and from the telecommunication line 1 A and is connected between the telecommunication line 1 A and control device 22. The image input device 26 includes an image input unit consisting of an image reading device and an electronic image input device or the like and an audio input unit such as a microphone and is connected to the control device 22 to input such input result to the control device 22. The printer 27 is connected to the control device 22 to output character data and image data or the like and print the characters and images on papers.

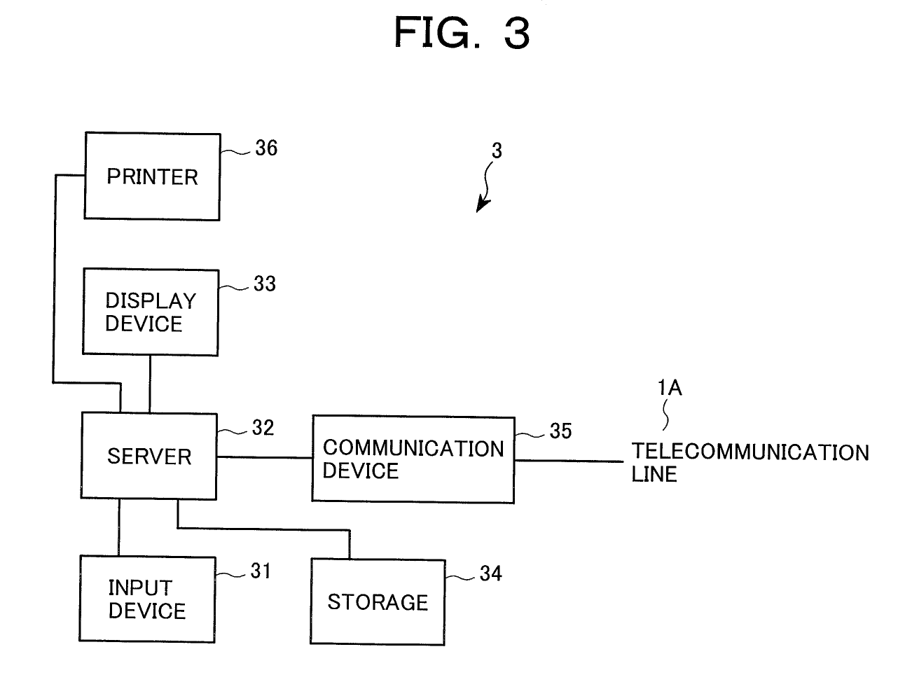

Next, the digital album provider terminal 3 in the provider side will be explained practically with reference to FIG. 3. FIG. 3 is a block diagram of the digital album provider terminal to be used for digital album registering and opening system of FIG. 1.

This digital album provider terminal 3 comprises an input device 31, a server 32, a display device 33, a storage 34, a communication device 35 and a printer 36. The input device 31 has an input unit such as a keyboard or the like and is connected to the server 32. The server 32 stores a running system for realizing the principal control operation of the present invention. The display device 33 is constituted of a CRT display or a liquid crystal display device or the like and is connected to the server 32 to display the transmitting/receiving screens and input screen or the like required for the provider. The storage 34 is formed of a large capacity hard disc or the like that can store the image data to be registered as a digital album and is connected to the server 32.

Moreover, this storage 34 comprises a member registration DB (database) (not illustrated) for storing various image data and including various pieces of information of members taking part in this system and a opening image management DB (not illustrated) including various information pieces such as the application condition and contract condition of the image information to be opened. The communication device 35 has a function to enable transmission and reception between the server 32 and telecommunication line 1. The printer 36 is connected to the server 32 to output character data and image data or the like to print characters and images on papers.

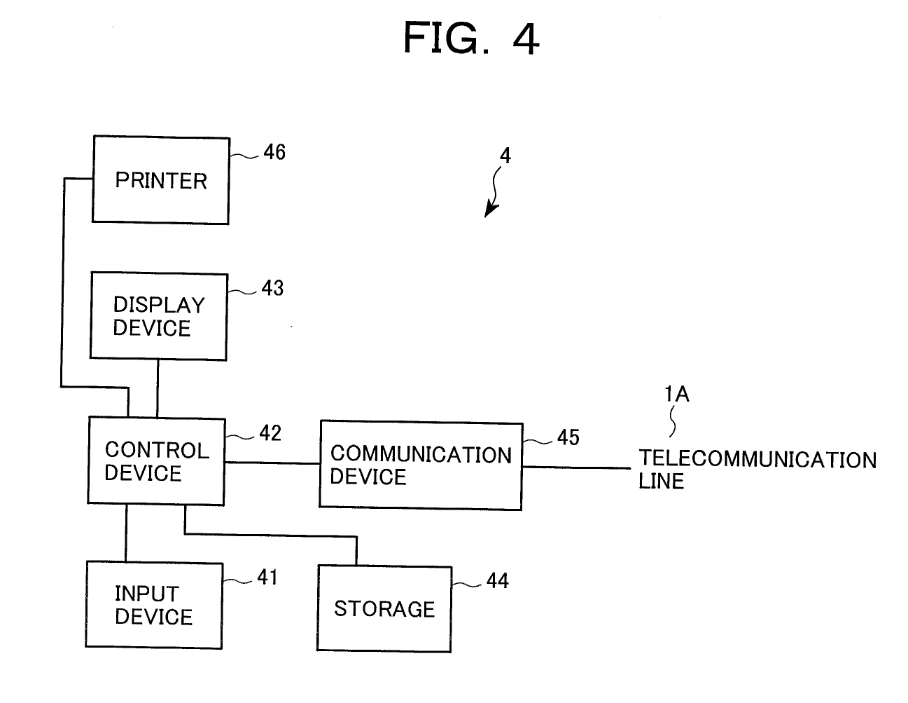

Next, the image user terminal 4 to be operated with an image user will be explained practically with reference to FIG. 4. FIG. 4 is a block diagram of the image user terminal used for the digital album registering and opening system of FIG. 1.

The image user terminal 4 is formed of a personal computer installing a browser and comprises an input device 41, a control device 42, a display device 43, a storage 44, a communication device 45 and a printer 46. The input device 41 has an input unit such as a keyboard or the like and is connected to the control device 42. The control device 42 is formed of a micro-computer to perform the predetermined step corresponding to the control operation of the digital album provider terminal 3. The display device 43 is constituted of a CRT display or a liquid crystal display device or the like and is connected to the control device 42 to display the transmitting and receiving screens and input screen or the like required for the image user. The storage 44 stores the intrinsic information of the image user and is connected to the control device 42. The communication device 45 has a function to enable transmission and reception of data between the control device 42 and telecommunication line 1. The printer 46 is connected to the control device 42 to output character data and image data or the like to print characters and images on papers.

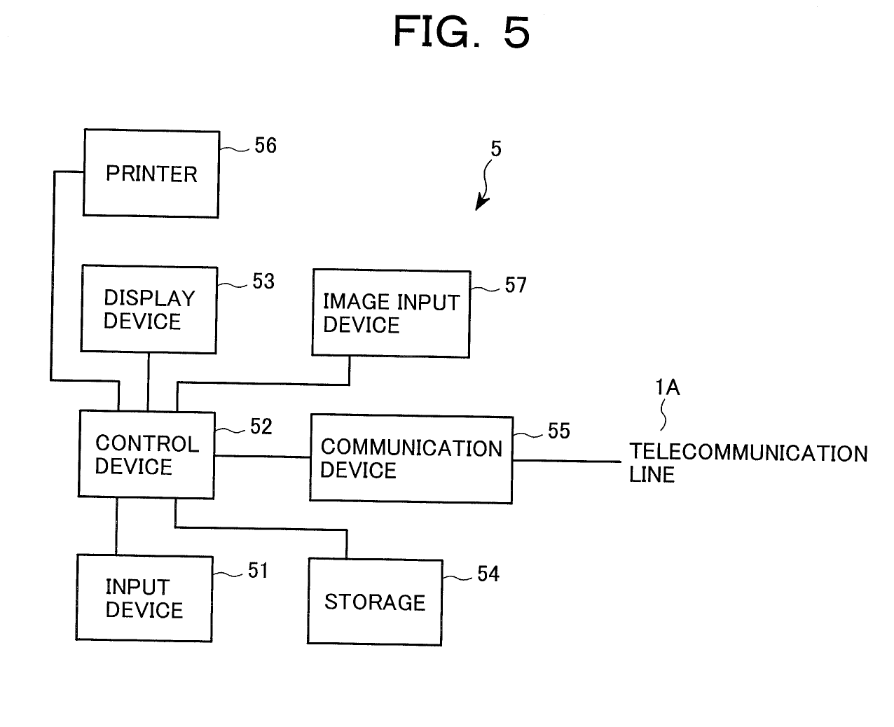

Next, the travel agency terminal 5 operated with a travel agency will be explained practically with reference to FIG. 5. FIG. 5 is a block diagram of the travel agency terminal used for the digital album registering and opening system of FIG. 1.

The travel agency terminal 5 is formed of a personal computer installing FTP (File Transfer Protocol) and comprises an input device 51, a control device 52, a display device 53, a storage 54, a communication device 55, a printer 56 and an image input device 57. The input device 51 includes an input unit such as a keyboard or the like and is connected to the control device 52. The control device 52 is constituted of a microcomputer or the like to perform the predetermined step corresponding to the control operation of the digital album provider terminal 3. The display device 53 is constituted of a CRT display or a liquid crystal display device or the like and is connected to the control device 52 to display the transmitting and receiving images and input image or the like required for the travel agency. The storage 54 is connected to the control device 52. The communication device 55 has a function to enable transmission and reception between the control device 52 and telecommunication line 1. This travel agency terminal 5 is used with both functions of the image registration terminal and image use terminal to provide services to those having no terminal, those who cannot make access to the provider with the telecommunication line and those who are planning travels.

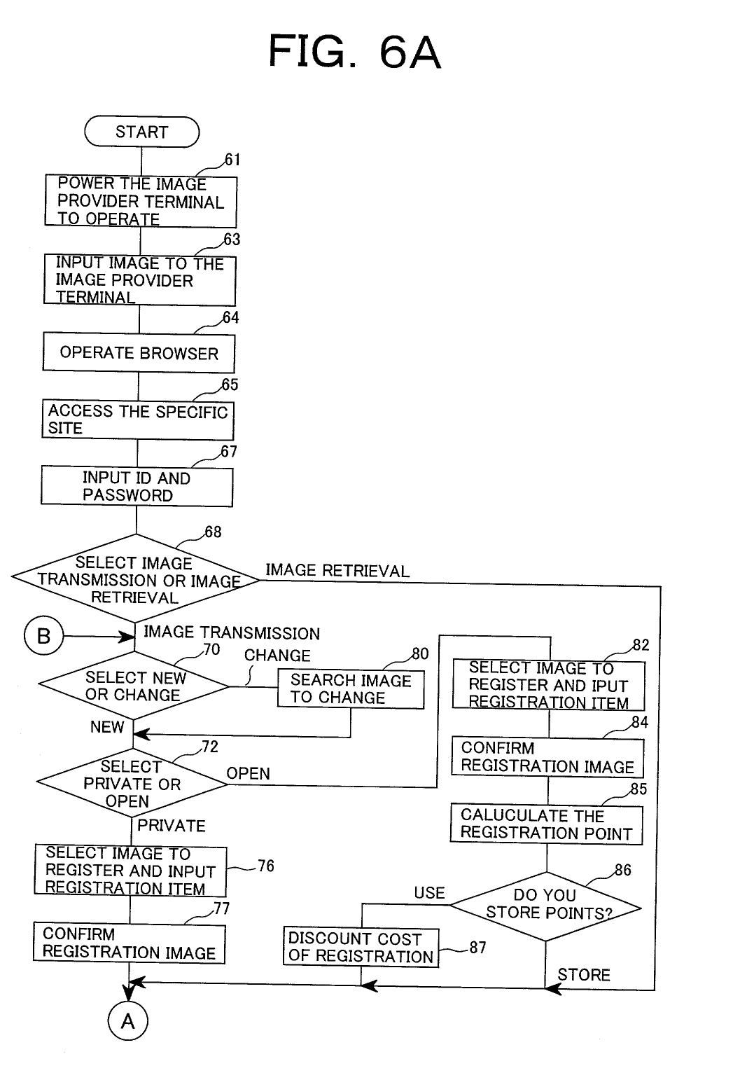

Next, operations of the digital album registering and opening system will be explained with reference to FIG. 6 to FIG. 23. FIG. 6 is an operation flow diagram of the digital album registering and opening system of FIG. 1.

The image provider, image user and travel agency previously make a contract with the provider to take part in this digital album registering and opening system to register the ID and password and to enable connection with the provider terminal 6 for the image provider terminal 2, image user terminal 4 and travel agency terminal 5. On the occasion of making this contract, it is thought that the required expense is set differently depending on the application contents, for example, the expense is set higher in such a case that the service is used for distribution of catalogues or the like.

As illustrated in FIG. 6A, the image provider terminal 2 is powered to drive the image provider terminal 2 (step 61). An image to be registered to the image provider terminal 2 is inputted (step 63). This image input can be made in various methods, for example, a media having the image picked up with a digital still camera or digital video camera is inserted into the image input device 26 of the image provider terminal 2 for reading of the image thereof and such image is then stored in the predetermined area, for example, of the storage 24, or such camera is connected to the image input device 26 for the input of image, or such camera is connected to a mobile radio terminal to input the image by radio to the image input device 26 from the mobile terminal.

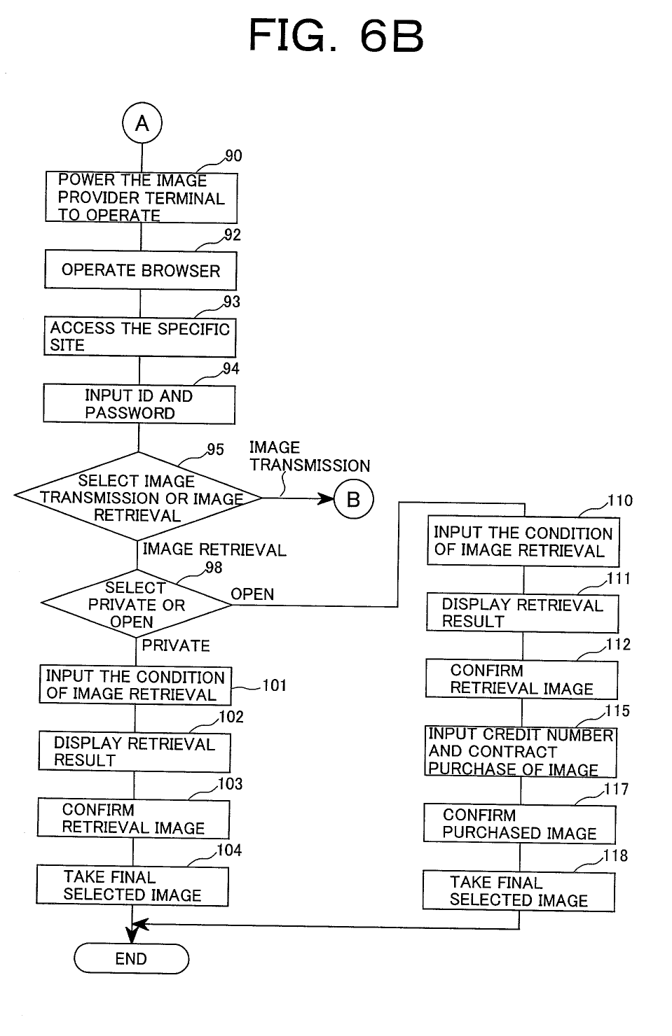

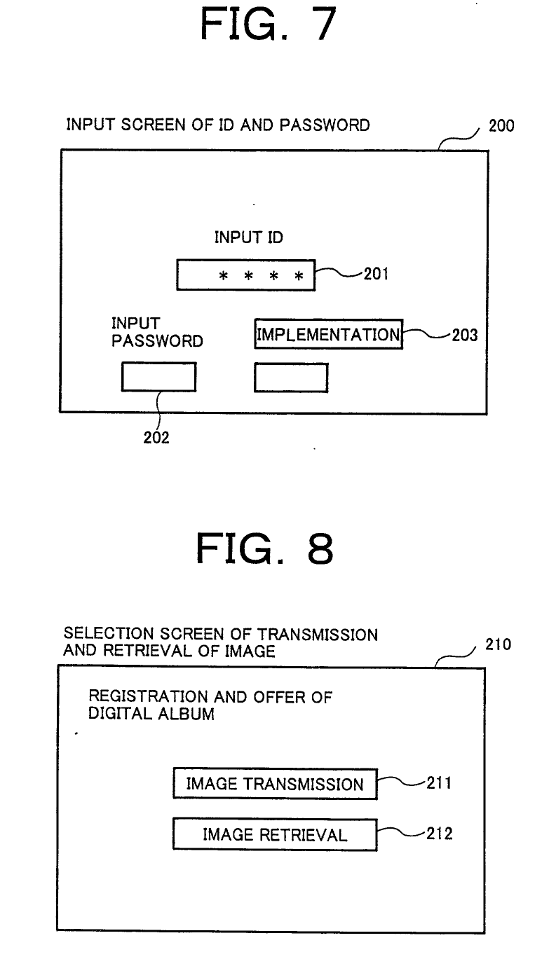

Thereafter, the image provider terminal 2 drives a browser (step 64) to make access to the specific site of the provider terminal 6 (step 65). With access to the specific site, the running system of the digital album provider terminal 3 displays the ID/password input screen 200 of FIG. 7 on the display device 23 of the image provider terminal 2. In this ID/password input screen 200, the ID and password of the image provider in the ID input column 201 and password input column 202 is inputted and the execution button 203 is then clicked (step 67) to identify a member. When a member is identified, the image transmission/retrieval selection screen 210 of FIG. 8 is transmitted from the digital album provider terminal 3 and is then displayed on the display device 23 of the image provider terminal 2. Therefore, the image provider can select any one of the image transmitting button 211 and image retrieval button 212 (step 68).

Thereby, the image provider can select the shift to the flow for newly registering an image by selecting the image transmitting button 211 (step 70) or the shift to the flow for reading and retrieving the image information already registered by selecting the image retrieval button 212 (step 90).

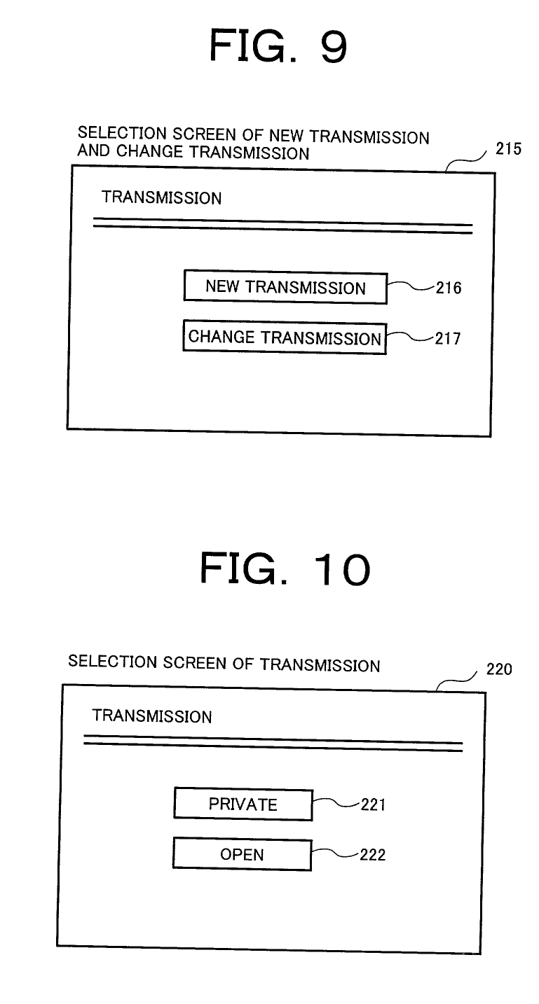

When going to the step 70 to newly register the images, since the new/change transmission selection screen 215 of FIG. 9 is transmitted and displayed from the digital album provider terminal 3, the image provider is capable of selecting an any one of the new transmission button 216 and change transmission button 217 (step 70).

Thereby, the image provider can select the shift to the flow for registering a new image (step 72) by selecting the new transmission button 216 or the shift to the retrieval flow for correcting image information already registered (step 80) by selecting the change transmission button 217.

When going to the step 72 for registering the new images, since the transmission selecting screen 220 of FIG. 10 is transmitted from the digital album provider terminal 3 and displayed on the display device 23 of the image provider terminal 2, the image provider can select any one of the private button 221 and opening button 222.

Thereby, the image provider can select at a time the image to be registered now as the image to be opened or as the private image on the transmission selection screen 220. Here, when the private button 221 is selected, the step goes to the step 76 and when the opening button 222 is selected, the step goes to the step 82.

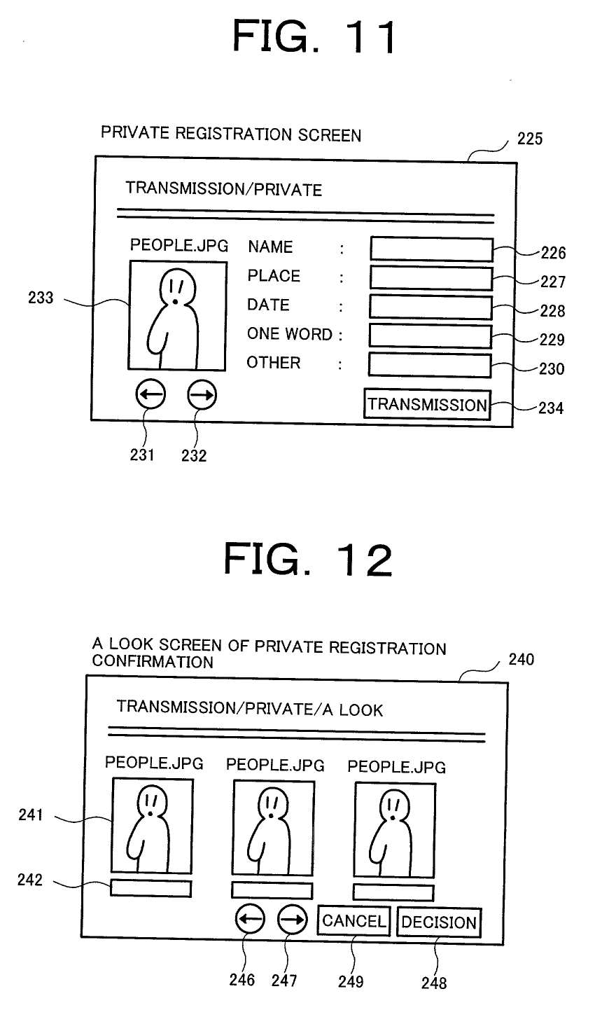

In the step 76 having selected the private button, the private registering screen 225 of FIG. 11 is transmitted from the digital album provider terminal 3 and displayed on the display device 23 of the image provider terminal 2. The control device of the image provider terminal 2 reads and displays, when it is instructed from the digital album provider terminal 3 to display the registration list screen 225, the image 233 to be registered first from the predetermined file of the storage 24. The image provider can input the retrieval information corresponding to the display image to the name input column 226, place input column 227, date input column 228, message input column 229 and other input column 230 on this registration list screen 225. In this embodiment, an image 233 to be displayed on the private registration screen 225 is explained with an example for calling the sequentially stored image 233 from the predetermined storage file of the predetermined storage 24. However, it is also possible to call an image by providing an input area for selecting the recording area of the image 233 to be called to this private registration image 225, for example, a file selection area provided with the pull-down menu.

In the retrieval information, it is also possible to input a writer-name in place of the true name, a building name such as Kyoto Ginkakuji-temple as the place, a photograph pickup date as the date, weather as one word and impression of photographer or the like as the other input data. Moreover, since the name of input person can be identified with the ID/password in the step 67, it is convenient that the input person is displayed with the default display method. Moreover, when the camera used to pickup an image has the position information and time information, it is also convenient to fetch such information to the place and date.

When a next image exists, the next button 232 is displayed to provide the accessible condition and when the next button 232 is clicked, the image 233 to be registered next is called from the predetermined recording file and is then displayed. Therefore, the relevant content is inputted to the input columns 226 to 230. The images to be registered are displayed in the input sequence. Each image and retrieval information are temporarily registered to the digital album provider terminal 3 by clicking the transmission button 234 after repeating such displays as many times as the number of images to be registered.

As explained above, the image displayed on the transmission selection screen 220 is the image 233 previously inputted to the image provider terminal 2. Moreover, in the case where correction and addition are made to the retrieval information in regard to the preceding image in this private registration input screen 225, the screen can be returned to the preceding input image screen by clicking the return button 231 and therefore the input such as correction and addition can be made to such screen.

When temporary registration is performed as explained above, the digital album provider terminal 3 transmits the look screen of private registration confirmation 240 to the image provider terminal 2. The image provider can officially register the temporarily registered image together with the retrieval information by confirming the look screen of private registration confirmation 240 and then clicking the decision button 248. Thereby, the digital album provider terminal 3 stores the temporarily registered content to the storage 34 to complete the private registration (step 77).

The confirming method in this step 77 will be explained practically. First, since a plurality of images (three images in this example) 241 and corresponding typical retrieval information 242, for example, place are displayed, the image provider confirms whether this content is YES or NO. When the next image exists, the next button 247 is displayed to provide the accessible condition and therefore the image to be confirmed next is displayed by clicking the next button 247. Therefore, it can be confirmed whether such content is YES or NO. After confirming the images up to the final image by repeating above step, the image can be registered officially by clicking the decision button 248. Here, confirmation can be made to the preceding image by clicking the return button 246. Moreover, if an image which shall not be registered is included, registration of such image can be stopped by selecting such image and then clicking the cancel button 249. Since the final confirmation can be made on the confirmation screen, only the images to be registered can surely be registered.

In this confirming method, a large image can be displayed and confirmation can therefore be done easily because a plurality of limited images are displayed on one screen. Moreover, since the typical retrieval information is displayed together with the images, important retrieval information can be confirmed easily.

As explained above, the image having the private information is received with the digital album provider terminal 3 and it is then stored as the digital album in the storage 34.

Meanwhile, it is requested to open the new image information at a time from the beginning, the step can be shifted to the step 82 to open at a time the image information by selecting, in the transmission selecting screen 220 of FIG. 10, by selecting the open button 222. When the open button 222 is selected, the digital album provider terminal 3 displays the open registration input screen 260 of FIG. 14 on the image provider terminal 2. In this open registration input screen 260, the images to be displayed are called from the predetermined file of the storage 24 and are sequentially displayed. Moreover, this open registration input screen 260 is provided with the retrieval information input column of the same content as that of the private registration screen 225 of FIG. 11. Therefore, the name input column 262, place input column 263, date input column 264, one word input column 265 and other input column 266 can be inputted as the retrieval information conforming to the image 261. When the next image exists, the next button 279 is displayed to provide the accessible condition and the image 261 to be registered next is displayed by clicking the next button 279. Thereby, the relevant content can be inputted to the input columns 262 to 266. The image and retrieval information can be temporarily registered by clicking the transmission button 280 after above step is repeated as many times as the number of images to be registered.

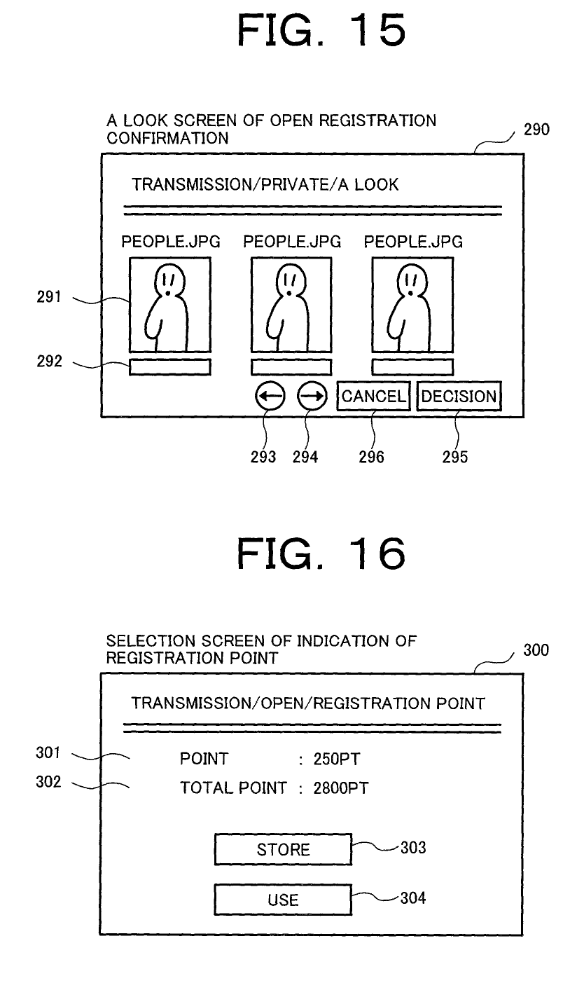

When the temporary registration is performed as explained above, since the look screen of open registration confirmation 290 of FIG. 15 is transmitted from the digital album provider terminal 3 and displayed, the image information including temporary registered open YES/NO information and retrieval information is officially registered to the open image management DB of the storage 34 (step 84) and is stored as the digital album in the storage 34 of the digital album provider terminal 3 by confirming the open registration confirmation list screen 290 and then clicking the decision button 295. Thereafter, the step goes to the step 85 of the open point adding flow.

The confirming method in the step 84 of this open registration flow will be practically explained.

As explained in the private registration, since a plurality of images (three images in this embodiment) 291 and the corresponding typical retrieval information 292, for example, place are displayed, whether this content is YES or NO is confirmed. When the next image exists, the next button 294 is displayed to provide the accessible condition, and thereby the screen to be confirmed next is displayed by clicking the next button 294. Therefore, whether this content is YES or NO is confirmed. After the images up to the final image is confirmed by repeating such step, the official registration is performed by clicking the decision button 295.

The preceding image can also be confirmed by clicking the return button 293. Moreover, if an image which shall not be registered is included, registration of this image can be cancelled by selecting such image and then clicking the cancel button 296.

Even in this method, since a plurality of limited images are displayed in one screen, a large image can be displayed and it can be confirmed easily. Moreover, since typical retrieval information can be displayed together with the image, important retrieval information can be confirmed easily.

As explained above, the information including the open information is transmitted from the digital provider terminal 2 and is then received with the digital album provider terminal 3, such image is then stored in the storage 34 as the digital album and registration content is registered and managed in the open image management DB.

The digital album provider terminal 3 calculates, in the step 85 of the open point adding flow, the point for opening and registration of each image for every image and changes the content to the open image management DB, obtains the total for every image provider to be identified with ID and causes the image provider terminal 2 to generate such content and then goes to the step 86.

This point means alleviation of storage expense of image information for the image provider terminal 2 and therefore it is possible to expect the positive opening and registration of image provider with generation of this point. Moreover, it is also possible to expect to open many images in higher quality by changing the point based on the opening conditions such as quality of image, number of images to be opened and input information amount or the like. Moreover, it is also effective to change the point depending on the application conditions of the images opened. For example, it is also possible to add the point of each image based on the number of times of retrieval and list-up and the number of times of output (transmission) to the image provider terminal 2. This point is counted up for every image information and changed and managed in the open management DB and is totaled for every image provided to be identified with the ID. How to use this total point can be selected in the registration point display selection screen 300 (step 86).

In this step 86, since the registration point display selection screen 300 is transmitted from the digital album provider terminal 3 and displayed on the display device 23 of the image provider terminal 2. Moreover, since the registration point display selection screen 300 includes the point 301 generated by this open registration and the total point 302 generated by the open registration in the past including the present open registration, the image provider can select how to use the point. As the selection for the point, any one of the use button 303 and store button 304 can be selected. When the store button 303 is selected here, the image transmission/retrieval selection screen 210 of FIG. 8 is displayed (step 68) and when the use button 304 is selected, the step goes to the step 87 to select a manner of use.

In the step 87 for selecting the way of using the points, the use selection display screen not illustrated is displayed and the image provider registers the image to this digital album registration and opening system via this display screen to select supplementation of storage expense or deposition of the corresponding cost to the predetermined finance institute. Upon completion of this step, the digital album provider terminal 3 instructs display of the image transmission/retrieval selection screen 210 of FIG. 8.

The flow for newly registering the image to this system as the private or open image has been explained above. However, in this embodiment, the image information that is once registered can be corrected. In this embodiment, it is possible to shift to the retrieval flow for correcting image information already registered by selecting the change transmission button 217 in the new/change transmission selection screen 215 of FIG. 9 (step 70).

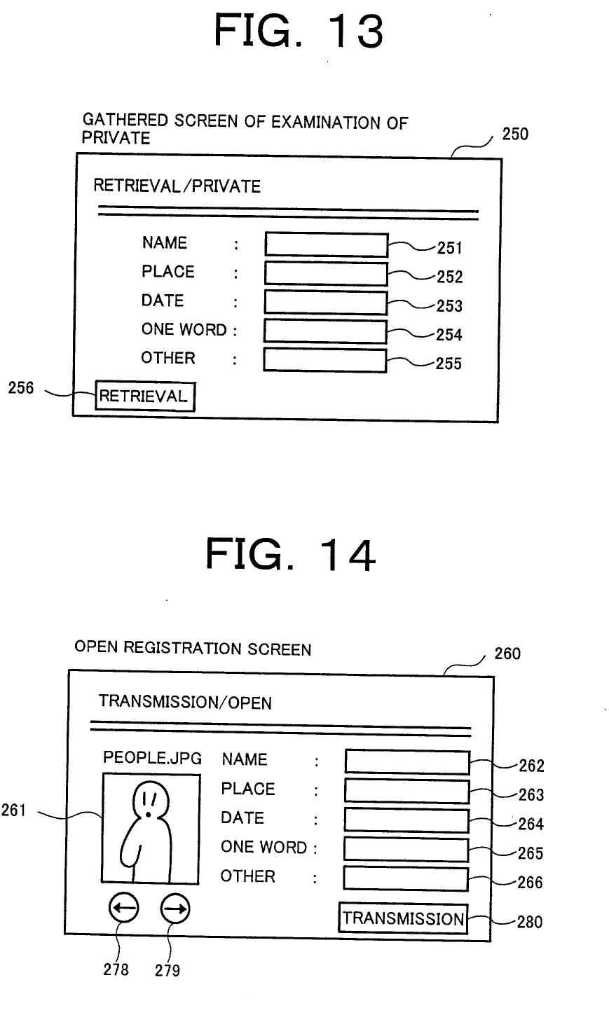

When going to the retrieval step 80 for correcting the image information, a gathered screen 250 of examination of private image of FIG. 13 is transmitted from the digital album provider terminal 3 and is then displayed on the display device 23 of the image provider terminal 2. In the gathered screen 250 of examination of private image, information is inputted to any one or more of the name input column 251, place input column 252, date input column 253, one word input column 254 and the other input column 255 as the retrieval information. When the retrieval button 256 is clicked here, the digital album provider terminal 3 retrieves the image information which is registered with the member name of the image provider from the digital album to retrieve the information matched with the retrieval condition (step 80). Thereafter, the step goes to the step 72 to select the private image or open image.

Namely, in this embodiment, the retrieval information of the image information extracted with the retrieval and open YES/NO can be selected by retrieving the image information already registered. Particularly, in this embodiment, the albums can be edited by correcting and changing the retrieval information of the image information registered as the private images. Moreover, when the open is selected in the next step 72 by reviewing the image information registered as the private images, such image information can be changed at a time to the open images.

Since the private registration can be changed to the open registration as explained above, it is possible to select that the image information is temporarily registered first as the private registration and it is changed to the open registration later. Thereby, the possibility of erroneous open of the image information which shall not be opened can be reduced.

In this embodiment, selection for private or open is executed at a time in the step 72, but it is also possible that such selection can also be executed for each image information by canceling the step 72 and considering the private registration screen 225 of FIG. 11 and the open registration screen 260 of FIG. 14 as one registration screen and providing the selection input column for open or private to this registration screen.

Next, the operation flow of the image user terminal 4 will be explained with reference to FIG. 6B. As illustrated in FIG. 6B, the image user terminal 4 is powered in the step 90 to start the image user terminal 4. The image user terminal 4 drives a browser (step 92) to make access to the specific site of the provider terminal 6 (step 93). The ID/password input screen 200 of FIG. 7 is displayed on the display device 43 of the image user terminal 4 by accessing this specific site. Since the image transmission/retrieval selection screen 210 of FIG. 8 is transmitted from the digital album provider terminal 3 and is displayed on the display device 43 of the image user terminal 4 when the ID and password of the image provider of the ID input column 201 and password input column 202 are inputted in this ID/password input screen 200 and then clicking the execution button 203 (step 94), an image user can select-any one of the image transmission button 211 and image retrieval button 212 (step 95).

Here, when the image transmission button 211 is selected, the step goes to the new registration flow explained previously or to the step 70 for correcting the registered image information. When the image retrieval button 212 is selected, the step goes to the step 98 for retrieving the digital album. Namely, it is also possible to shift to the flow of new registration and correction of image information by selecting the step 70 to cause the image user terminal 4 to function as the image provider terminal 2.

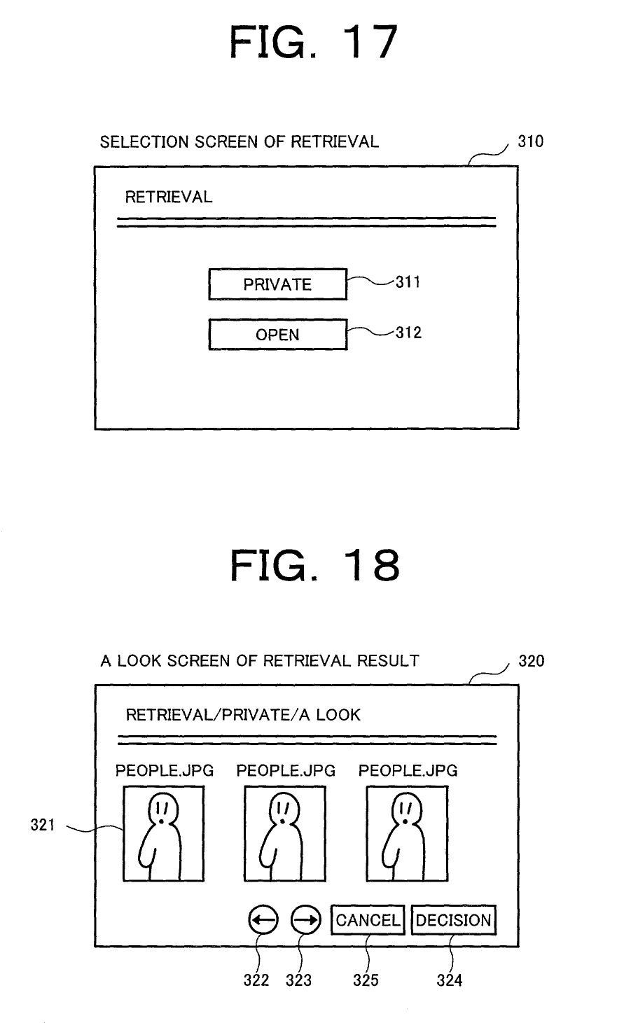

In the step 98 for retrieval, since the retrieval selection screen 310 of FIG. 17 is transmitted from the digital album provider terminal 3 and is displayed on the display device 43 of the image user terminal 4, a user can select any one of the private button 311 and open button 312. Namely, in the image user terminal 4 of this embodiment, an image user can shift to the private retrieval flow for retrieving all image information pieces registered by himself to this system by selecting the private button 221. On the other hand, an image user can shift to the open retrieval flow for retrieving all image information pieces opened in this system by selecting the open button 312. In this sense, the image user terminal 4 of this embodiment has a function of the image provider terminal 2. It is of course possible that the image user terminal 4 is used only for retrieving the private image or open image in the step 98 after shifting from the step 94 by canceling the step 95. Moreover, the image user terminal 4 can be used only for retrieving the open image information in the step 110 after shifting from the step 94 by canceling the steps 95 and 98.

In the step 101 of the private retrieval flow, the gathered screen of examination of private image 250 of FIG. 13 is transmitted from the digital album provider terminal 3 and displayed on the display device 43 of the image user terminal 4. Therefore, a user can instruct the retrieval of the image information which is registered with the image provider as the private or open image information by inputting the information to any one or more of the name input column 251, place input column 252, date input column 253, one word input column 254 and the other input column 255 as the retrieval condition columns and then clicking the retrieval button 256. When the retrieval instruction is issued, the digital album provider terminal 3 retrieves the image information registered with the ID of the image provider from the image information stored in the storage 34 under the retrieval condition explained above and displays such image information together with a look screen of retrieval result 320 of FIG. 18 on the image user terminal 4 (step 102).

The retrieval image can be confirmed in this look screen of retrieval result 320 (step 103). This confirming method will be explained in more practical. Since a plurality of images (three images in this example) 321 are displayed, whether this content is YES or NO is confirmed. When the next image exists, the next button 323 is displayed to provide the accessible condition. Since the image to be confirmed next is displayed by clicking the next button 323, whether this content is YES or NO is confirmed. After the images are confirmed up to the final image by repeating such step, selection is executed when the decision button 324 is clicked and thereafter the step goes to the step 104.

The preceding image can also be confirmed by clicking the return button 322 in the look screen of retrieval result 320 and if an unnecessary image is included, it is possible to cancel such image by selecting it and clicking the cancel button 325.

Shifting to the step 104, the final selection image display screen 330 is transmitted from the digital album provider terminal 3 and is then displayed. Therefore, the finally selected image 331 is fetched into the storage 44 of the image user terminal 4 and stored therein together with the retrieval information 335 by clicking the decision button 334 after the final confirmation. The edition and printing or the like can be done in the image user terminal 4 by utilizing the image stored in the storage 44.

In the final selection image display screen 330, one image 331 is displayed and the retrieval information 335 is also displayed in one screen and thereby contents can surely be confirmed. Moreover, when a plurality of images are selected, the preceding and successive images can be confirmed by clicking the prior button 332 and next button 333.

As explained above, in this embodiment, the image information registered with an image provider can be watched, printed out or down-loaded by retrieving it under the desired retrieving conditions and therefore it is now possible to extract such image information by making access to the digital album provider terminal 3 whenever required without self-storage and self-management.

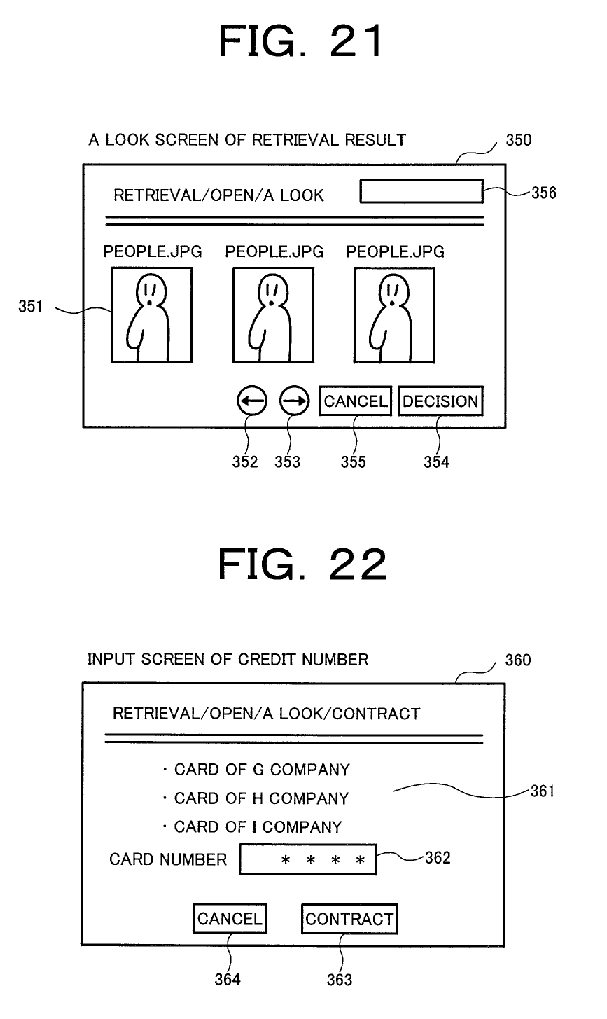

On the other hand, going to the step 110 of open retrieval flow, since the gathered screen of examination of the open image 340 is transmitted from the digital album provider terminal 3 and displayed, an image user can instructs the retrieval of image information open-registered to the digital bank by inputting the information to any one or more columns of the name input column 341, place input column 342, date input column 343, one word input column 344 and the other input column 345 as the retrieval condition columns. When the image information retrieval is instructed, the digital album provider terminal 3 retrieves the image information open-registered in the storage 34 under the retrieval condition and only the matched image information is displayed together with the look screen of retrieval result 350 of FIG. 21 on the image user terminal 4 (step 111).

In this look screen of retrieval result 350, the retrieval image can be confirmed (step 112). This confirming method will be explained in more practical. Since a plurality of images (three images in this example) 351 are displayed as in the case of the step 103, whether this content is YES or NO is confirmed. When there is the next image, the next button 353 is displayed to provide the accessible condition. When the next button 353 is clicked, the image to be confirmed next is displayed and therefore whether this content is YES or NO is confirmed. After the images are confirmed up to the final image by repeating such step, the decision button 354 is clicked for selection. Here, the step goes to the step 115 of the image purchasing contract flow. The preceding image can also be confirmed by clicking the return button 352 in the look screen of retrieval result 350 and moreover if an unnecessary image is included, selection of such image can be canceled by selecting such image and then clicking the cancel button 355.

Going to the step 115 of the image purchasing contract flow, since the credit number input screen 360 of FIG. 22 is transmitted from the digital album provider terminal 3 and is then displayed, when the card name of the applicable credit company is selected, the card number is inputted to the card number input column 362 and the contact button 363 is clicked, the digital album provider terminal 3 determines that payment contract has been agreed, allowing the step to go to the step 117 for confirming the purchased image. Here, the retrieval operation can be completed by clicking the cancel button 364 in the credit number input screen 360. Moreover, an advertisement 356 can also be displayed and the storage expense of the image provider can be reduced by sharing the storage expense to the advertisement company.

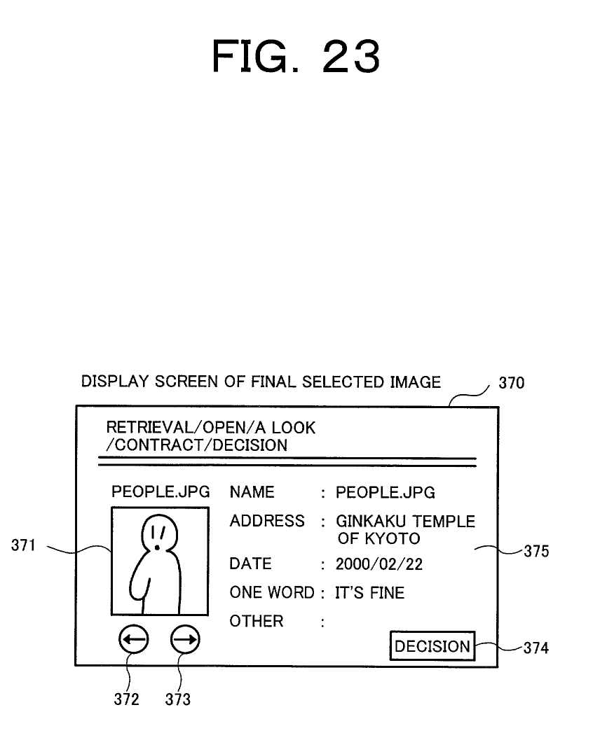

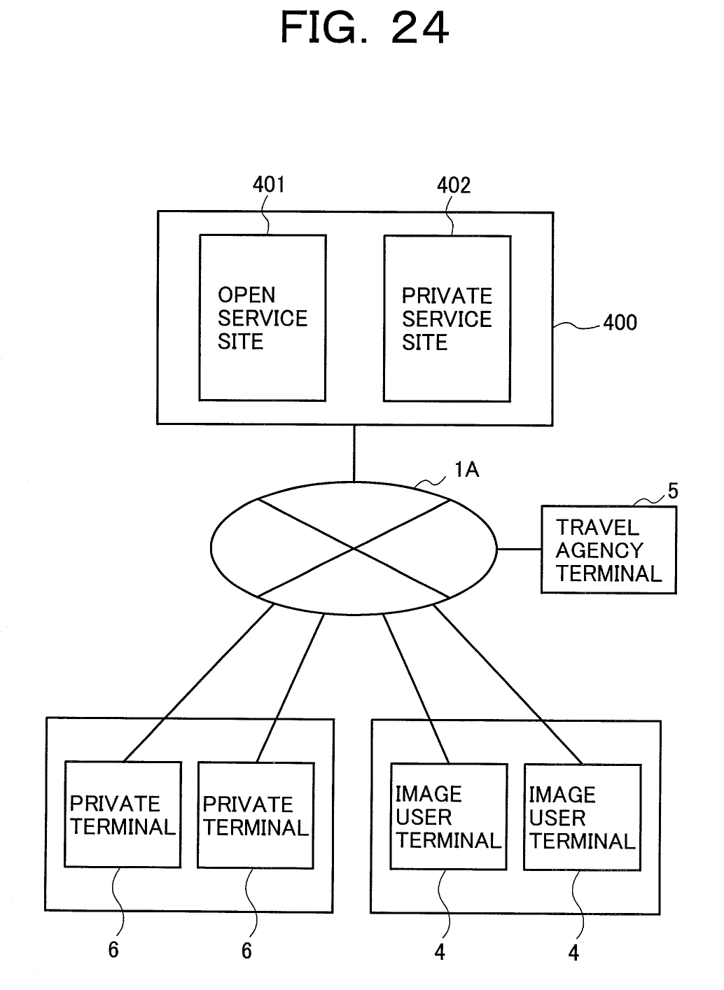

Going to the step 117 for confirming the purchased image, the display screen of final selected image 370 of FIG. 23 is transmitted from the digital album provider terminal 3 and displayed. When the final confirmation is made and the decision button 374 is clicked, the final selected image 371 is fetched and stored in the storage 44 of the image user terminal 4 together with the retrieval information 375. The image user can edit and print out the image stored in this storage 44 at the image user terminal 4.

In the display screen of final selected image 370, since one image 371 is displayed and the retrieval information 375 is also displayed on one screen, the contents can surely be confirmed. Moreover, when a plurality of images are selected, the preceding and successive images can be confirmed by clicking the prior button 372 and next button 373.

In above operation flow, the image provider terminal 2 and the image user terminal 4 are physically separated in the explanation but these terminals may be the same terminal physically as explained above. However, the functions of the image provider terminal 2 and the image user terminal 4 are considered separately.

Moreover, in regard to the registration and retrieval operations of the travel agency terminal 5, since these are identical to that of the image provider terminal 2 and image user terminal 4, the operation flows of such operations are not explained.

In above embodiment, the image provider terminal 2 is connected to the provider terminal 6 via the public telephone circuit and the image information is inputted by repeating transmission and reception between the image provider terminal 2 and digital album provider terminal 3. But, it is also possible to give the function as the terminal to the digital camera and digital video camera itself and to register the image by transmitting by radio the obtained image to the provider terminal 3 with the single operation. In this case, the position information and date information or the like provided in the camera are used as the input information, the open YES/NO information is inputted simultaneously with the photographing by providing a switch to input the open YES/NO condition and moreover the operation flow explained above is automatically executed in the side of provider having received such information. Thereby, image can be registered simply and the images can sequentially be registered immediately after the pick-up of image or during photographing of images. As explained above, when an image has been registered quickly, the worth of the image to be opened becomes higher.

Particularly, the travel agency is required to offer the profile of destination with the latest and practical image to the prospective traveler and therefore it is specifically effective to use the open image explained above. Moreover, it is also considered to expect increase of the prospective travelers by obtaining the latest image of destination and then registering and opening the image by entrusting a camera to a traveler.

In the present invention explained above, it is no longer required to, by separately registering the private image and open image to the digital album provider terminal, store the image to the terminal owned by the image provider, the third party can conveniently use this open image, the storing expense of image can be shared to a user of the open image (image retrieving person and advertisement agency for inserting the advertisement to the open image or the like) to reduce the storing expense of the image provider and many open images can be collected by promoting the participation of the image provider.

Moreover, since it is possible to retrieve the information such as photographing place and date, a user who is planning the travel can detect the profile of the destination and prepare for the travel through the retrieval based on the traveling place and the latest date. A user who wants to obtain the scenery of a certain place in a certain season and to use such scenery can get such image through the retrieval based on such place and season and also can get the desired image by adding particularly one word and the other information to the retrieval conditions.

In the embodiment explained above, both image provider terminal 2 and image user terminal 4 can register the image to the digital album of the storage 34 of the digital album providing terminal 3 or can use the image registered in the digital album through retrieval thereof by making access to the specific electronic service site opened with this digital album service company. Particularly, since the digital album stores the image including the open YES/NO information, there is no overlap of the image information and thereby capacity of the storage 34 can be alleviated. However, the present invention is never limited thereto. Namely, the open YES image among the images offered by the image provider can be stored merely in the other storage area. In this case, it is also possible that the open YES image is stored in the storage area separately from the open NO image or the open YES image is copied and stored in the other storage area. Moreover, it is also possible to open the electronic service site for storing these open YES images as the digital open album and to open such image only to the image user terminal.

FIG. 24 illustrates an embodiment of the profile that the open YES image is copied to open the open service site 401 and private service site 402. Namely, the digital album service company 400 that is running such two service sites establishes the digital album registering and opening system by connecting a plurality of private terminals 6, a plurality of image user terminals 4 and the travel agency terminal 5 via the public telephone circuit 1A forming the telecommunication line.

The digital album company 400 explained above opens the open service site 401 and private site 402 by providing one or a plurality of servers and a large capacity storage. The private site 402 stores the digital private album information stored by accumulating the image information provided with the retrieval information offered from the private terminal 6 and the member registration DB of the members offering the images by utilizing such private service site 402. Moreover, the open service site 401 stores the digital open album information stored by accumulating the open YES image information among the image information offered from the private terminal 6 and the member registration DB utilizing the open service site 401.

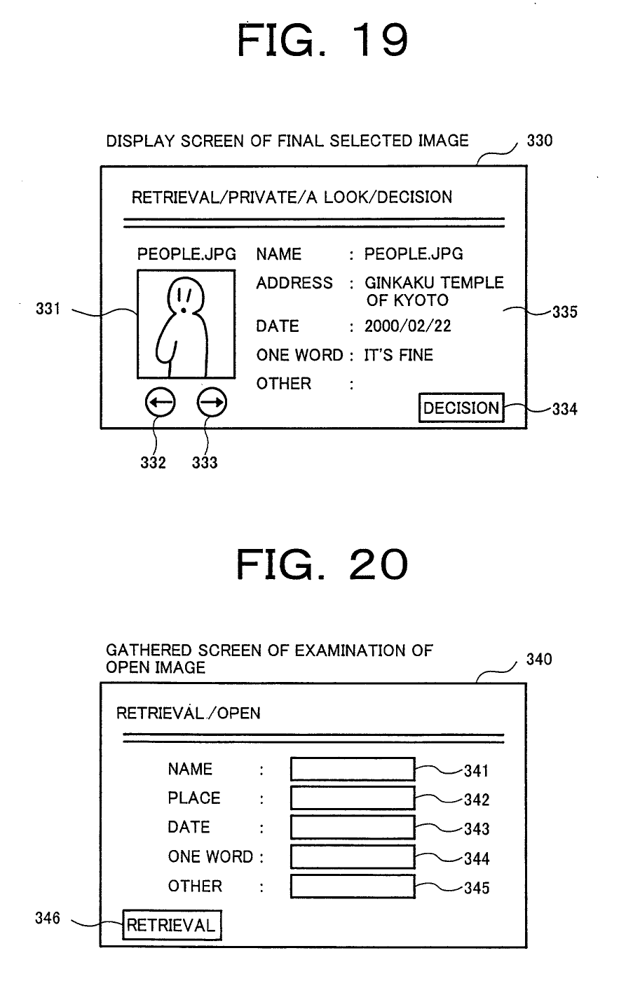

Moreover, the private terminal 6 is provided with the operation function to execute, for the private service site 402, the image registration and correction flow indicated with the operation flow of FIG. 6A. Moreover, in FIG. 6A, when the image retrieval button 212 is selected in the step 68, the step goes to the step 101 of FIG. 6B to execute the private retrieval explained in regard to FIG. 13, FIG. 18 and FIG. 19. Namely, this private terminal 6 is capable of registering, by making access to the private service site 402, the image photographed by itself, extracting an image by freely retrieving and editing such registered image and also registering the image photographed by itself as the open image.

On the other hand, the basic operation flow is identical to that of FIG. 6B in the image user terminal 4. However, the image user terminal 4 is also provided with the operation flow to go to the step 110 when the member authentication is completed because it makes access, in the step 93, to the open service site 401 having recorded only the open YES image information.

As explained above, the digital album company 400 is provided with the electronic service site running system for opening two electronic service sites 401, 402 by preparing a mechanism to store the image information and apply the transaction and enabling connection of such electronic service sites with a plurality of user terminals (private terminal 6 and image user terminal 4) via the telecommunication line and this running system stores the image information given the open YES information as the digital open album information by accepting the image information having the open YES/NO information and retrieval information from the user terminal (private terminal 6), opens the electronic service site (open service site) to open the digital open album information, accepts the retrieval request to the electronic service site (open service site) from the user terminal (image user terminal 4) and retrieves the image information matched with the retrieval request from the digital open album information based on the retrieval request in order to provide the retrieval result to the user terminal (open service site).

Moreover, the running system moreover stores the received image information as the digital private album information by accepting the image information including the open YES/NO information and retrieval information from the user terminal (private terminal 6), opens the electronic service site (private service site) which can retrieve, edit and output this digital private album information, accepts the retrieval request for the electronic service site (private service site) from the user terminal (private terminal 6), and retrieves, based on the 5 retrieval request, the image information matched with the retrieval request from the digital private album information in order to provide this retrieval result to the user terminal (private terminal 6).

According to this embodiment, the system can be structured by clearly separating the sites for private use and use of the opened image and thereby privacy can be protected easily.

Moreover, according to the present invention, it is no longer required to store the image into the image provider terminal registering the image information including the open YES/NO information to the digital album provider terminal, the third party can conveniently use the registered open YES image information and the digital album registering and opening method and digital album registering and opening system that can promote the participation of many users can be provided.

What is claimed is:

1. An electronic service site running system for opening the electronic service sites by preparing a mechanism to realize storing of image information and application of transaction and for connecting a plurality of terminals to the electronic service site via the communication line; said running system accepts the image information including the open YES/NO information and retrieval information from an image provider terminal;
stores the image information given the open YES information as the digital open album information to open this digital open album information in the electronic service site; and
accepts the retrieval request to said electronic service site from a image user terminal and retrieves the image information matched with said retrieval request from said digital open album information based on said retrieval request to provide the retrieval result to said image user terminal.

2. The digital album site running system according to claim 1, wherein said running system stores said registered image information as the digital private album information and retrieves, edits and outputs this digital private album information via the electronic private service site; accepts the retrieval request for said electronic private service site from said image provider terminal having requested registration of said image; retrieves the image information matched with said retrieval request from said digital private album information based on said retrieval request; and provides the retrieval result to said image provider terminal having requested storage of said image.

3. The digital album site running system according to claim 1, wherein said running system is provided with a database for recording the points of the image provider and the points of the database of image provider having offered the open image are changed based on the application conditions of the open image retrieved in said open service site.

4. The digital album site running system according to claim 2, wherein the storage expense for said digital private album information stored with the image provider having offered the open image is alleviated based on the application condition of the open image retrieved with said open service site.

5. The digital album site running system according to claim 4, wherein said running system is provided with a database for recording the points of the image provider, the points in the list of the image providers having offered the open images are changed based on the application condition of open image retrieved with said open service site, and the storage expense of said digital private album information of which points are stored with the image provider is alleviated based on the request from said image provider terminal.

6. The digital album site running system according to claim 1, wherein said running system accepts the image information including open YES/NO information, position information and date information from the image provider terminal and temporarily stores said information and determines the open YES/NO information of said image information temporarily stored based on the confirmation information from said image provider terminal in order to store the image information given the open YES information as the digital open album information.

7. The digital album site running system according to claim 1, wherein the image information provided to the image user terminal together with said retrieval result is provided together with the advertisement information.

8. A digital album opening method of electronic service site for opening the electronic service site by preparing a mechanism to store the image information and makes application of transaction and connecting a plurality of terminals to this electronic service site via the communication line, wherein the image information including the open YES/NO information and retrieval information is accepted from the image provider terminal, the image information given the open YES information is stored as the digital open album information and this digital open album information is opened in the electronic service site, the retrieval request for said electronic service site is accepted from the image user terminal, the image information matched with said retrieval request is retrieved from said digital open album information based on said retrieval request and the retrieval request is offered to said image user terminal.

9. The digital album opening method according to claim 8, wherein said registered image information is stored as the digital private album information and this digital private album information is retrieved, edited and outputted via the electronic private service site, the retrieval request for said electronic private service site is accepted from said image provider terminal having requested registration of said image, the image information matched with said retrieval request is retrieved from said digital private album information based on said retrieval request and the retrieval result is offered to said image provider terminal having requested storage of said image.

10. A digital album registering and opening method comprising the steps of:
receiving, with the digital album provider terminal, the image information including the open YES/NO information and retrieval information transmitted from the image provider terminal via the communication line;
storing said received image information to the storage of said digital album provider terminal as the digital album;
accepting the retrieval request information with said digital album provider terminal via the communication line from the image user terminal and said image provider terminal;
retrieving the image information matched with said retrieval request information from said digital album based on said retrieval request information; and
providing said retrieved image information to said image provider terminal without relation to open YES/NO conditions and also providing only the open YES image information to said image user terminal.

11. The digital album registering and opening method according to claim 10, comprising a step to alleviate the image information storage expense for said image provider terminal having provided said open YES image information based on the condition for providing said open YES image information.

12. The digital album registering and opening method according to claim 10, comprising a step to change said digital album image information open YES/NO information from the image provider terminal.

13. THE digital album registering and opening method according to claim 10, wherein said retrieval information includes position information and date information.

14. A digital album registering and opening system comprising a digital album provider terminal to which the image provider terminal and image user terminal are connected via the communication line, wherein the digital album provider terminal includes a server and a storage, while said server has the functions for:
receiving the image information including the open YES/NO information and retrieval information transmitted from the image provider terminal via the communication line;
storing said received image information to said storage as the digital album;
accepting the retrieval request information from said image provider terminal and image user terminal via the communication line;
retrieving the image information matched with said retrieval request information from said digital album based on said retrieval request information; and
providing said retrieved image information to said image provider terminal without relation to the open YES/NO information and also providing only the image information having the open YES information to said image user terminal.

15. The digital album registering and opening system according to claim 14, wherein said server has the functions for:
storing said received image information to said storage as the digital private album;
accepting the retrieval request from said image provider terminal for said digital private album;
retrieving the image information matched with said retrieval request from said digital private album based on said retrieval request; and
providing the retrieval result to said image provider terminal having requested the storage of said image.
